(19) United States
(12) Patent Application Publication
(10) Pub. No.: US 2003/0019939 A1
(43) Pub. Date: Jan. 30, 2003

(54) Data acquisition and processing system and method

(76) Inventor: Abigail Jane Sellen, Newbury (GB)

Correspondence Address: HEWLETT-PACKARD COMPANY, Intellectual Property Administration, P.O. Box 272400, Fort Collins, CO, 80527-2400, US

(21) Appl. No.: 10/206,354

(22) Filed: Jul. 29, 2002

(30) Foreign Application Priority Data
Jul. 27, 2001 (GB) 0118432.4

(51) Int. Cl. G06K 7/10; G06K 9/22

(52) U.S. Cl. 235/462.45

(57) ABSTRACT

A data acquisition and processing computer system (10) includes a data acquistion device, which may be a scanner (12) for acquiring data (20) relating to an audio/visual/audio-visual product (22). A network element typically a PC (14) or a server (16) contains records relating to a plurality of audio/visual/audio-visual recordings. A network connection, such as a wireless connection, (38) connects said data acquisition device (12) to said network element (14,16). A processor identifies a record that relates to said data (20) and outputs information relating to said identified record via a screen (28) or a loudspeaker (29).

This invention relates to a data acquisition and processing system and method. More particularly, but not exclusively, it relates to a data acquisition and processing system and method for data relating to audiovisual/audio/visual products.

Current systems allow the scanning of barcodes and the correlation of these barcodes to an item description and price. Such a system is used, for example, in supermarkets where a shopper can scan barcodes from their purchases into a portable device and produce their own receipt for payment at a till.

A problem associated with this system is the limited storage of the portable device that limits the number of items about which information can be stored.

It is also known for a portable scanner to be used to scan portions of text from, for example, a poster that are then downloaded onto a network. The network has a database hosted upon, for example, a PC which contains the text information relating to it. The PC can compare the scanned portion of text to the text stored within the database and provide information to the user such as, where to purchase the text and the cost of the text.

A problem associated with this arrangement is that non-visual, or encoded data relating to an article cannot be detected.

It is an object of the present invention to provide a data acquisition and processing system that, at least partly, ameliorates at least one of the above-mentioned problems.

It is a further object of the present invention to provide a data acquisition and processing method that, at least partly, ameliorates at least one of the above-mentioned problems.

According to a first aspect of the present invention there is provided a computer system comprising portable data acquisition means for acquiring data relating to an audio/visual/audio-visual product; a network element containing records relating to a plurality of audio/visual/audio-visual recording; connection means for connecting the data acquisition means to the network element; processing means for identifying a record relating to the acquired data and output means arranged to output information relating to the identified record wherein the record is arranged to store a portion, or all, of each of the recordings upon which it contains information.

A visual display may be provided upon which at least a portion of said additional information can be displayed. This may cmprise a part of the portable device, or may be part of a separate device connected across the network to the network element, such as a personal computer.

The output means may be arranged to output a portion, or all, of one of the recordings stored upon the database is response to a user generated input from input means.

A user of the system may be directed to a Website associated with a provider of at least one of the recordings.

This system has the advantage of allowing a user to acquire information about a musical track, or video, whilst they are away from their base and PC, for example, shopping or at the cinema, and review a small portion of the track, or video, at their leisure before deciding whether to purchase it or not.

The information may be audio and/or video data. The information may be streamed to this output means.

By portable we mean that the device is typically, pocket sized, hand held and battery operated.

The data acquisition means may be a scanner, for example, a Capshare™ device manufactured by Hewlett Packard. The data acquisition means may be a bar code reader. The bar code reader may typically include an infrared emitter and a photosensitive receiver. The data acquisition means may be a magnetic reader.

This range of possible types of data acquisitions means allows a variety of coded data to be used thereby increasing the utility of the systems and allows interoperability with existing systems.

The additional information which is output by the network element may comprise any one, or combination, of the following visual/audio-visual information: a video accompanying the record, a picture, a portion of text. It may comprise a web-page or a web address. Other forms of visual information not described are also envisaged.

The data may be output in any one or combination of the following forms from this non-exhaustive list: pictorial, textual, numerical, barcodes, magnetically coded, passive radio-frequency tag, Glyph™.

The network element may be associated with the data acquisition means. Alternatively, it may be a PC or a server. The network element may connect to any one, or combination of, the following types of network: intranet, extranet, internet, WAN, LAN, MAN, PLMN, PSTN, the Internet. The network element may connect to a network either via a wireless network connection or via a hardwired network connection. The wireless network connection may be a wireless LAN connection, for example, employing a IEEE 802.11 or a Bluetooth connection employing Bluetooth data transfer protocols. Alternatively, the wireless network connection may be a cellular telecommunications connection, for example, employing GSM, UTMS, WAP, SMS, GPRS, or any other suitable cellular telecommunications protocol.

The records may be held on a database or in any other suitable data array. The records may be accessed via the World Wide Web. The database may be a web site. The records may contain information relating to any one, or combination, of the following types of information: name of the product; artist; producer and/or director of the recording; release date; releasing company; biography of the artist; other works by the artist; similar works by other artists/directors/producers.

This allows a user of the system to obtain information about the work/product prior to making a decision whether to purchase it or not. The record may store a portion, or all, of each of the recordings upon which it contains information.

The output means may output a portion, or all, of one of the recordings stored within the record is response to a user generated input from input means. The output means may be either or both of a screen or an audio device. The audio device may be a loudspeaker or it may be headphones. The output means may be a component of the data acquisition device.

The processing means may be associated with the data acquisition means. Alternatively, the processing means may be associated with the network element.

According to a second aspect of the present invention there is provided a method of acquiring and processing data comprising the steps of:

acquiring data relating to an audio/visual/audio-visual product by data acquisition means;

hosting records containing data relating to a plurality of audio/visual recording on a network element;

connecting the data acquisition means to the network element;

identifying a record that corresponds to the acquired data; and

outputting, at least a portion of, the recording associated with the identified record.

The method may include providing the data in the form of any one, or combination, of the following forms: textual, numerical bar codes, magnetically coded, passive radio frequency.

The method may include providing the network element associated with the data acquisition means. Alternatively, the method may include providing the network element in the form of a PC or a server. The method may include connecting the network element to a network. The method may include providing the network in any one, or combination, of the following: intranet, extranet, internet, WAN, LAN, MAN, PLMN, PSTN, the Internet.

The method may include connecting the data acquisition means to the network element by any one, or combination, of the following: wireless network connection, for example IEEE 802.11 or Bluetooth, temporary hardwired connection, for example, USB, serial or parallel data buses, cellular telecommunication link possibly including any one, or combination of: GSM, UTMS, GPRS, SMS and WAP protocols and possibly including a cellular base station.

The method may include providing the data acquisition means in any one, or combination, of the following forms: a scanner, bar code reader, magnetic reader.

The method may include providing the data acquisition means in a pocket sized, hand held, battery operated form.

According to a third aspect of the present invention there is provided a portable data acquisition device comprising data capture means, storage means, wireless data transfer means, the data capture means being arranged to capture data relating to an audio/visual/audio-visual product, the storage means being arranged to store the data and the wireless data transfer means being arranged to transfer the data to a network element.

The data capture means may be any one, or combination, of: a scanner, a bar code reader, a magnetic reader.

The storage means may be non-volatile RAM.

The wireless data transfer means may be a wireless network transceiver for example a wireless LAN transceiver utilising IEEE 802.11 data transfer protocol and/or a Bluetooth transceiver. The wireless data transfer means may be a cellular telecommunications transceiver, for example employing any one, or combination of, the following: GSM, UTMS, GPRS, SMS or WAP.

According to a fourth aspect of the present invention there is provided a computer readable medium having stored therein instructions for causing a processing unit to act as the network element according to either the first or second aspects of the present invention.

According to a fifth aspect of the present invention there is provided a program storage device readable by a device and encoding a program of instructions for causing the device to act as the portable data acquisition means according to either of the first or second aspects of the present invention, or as the portable data acquisition device according to the third aspect of the present invention.

According to a sixth aspect the invention provides a computer readable medium having stored therein instructions which when running on a processor of a portable data acquisition device cause said device to perform the steps of:

acquiring data relating to an audio/visual/audio-visual product;

connecting said data acquisition means to a network element which hosts records containing data relating to a plurality of audio/visual recordings;

receiving from said network element at least a portion of said recordings associated with said identified record in said network element,

and presenting said received portion of recording to a user on a display associated with said portable data acquisition device.

The invention will now be described, by way of example only, with reference to the accompanying drawings, in which:

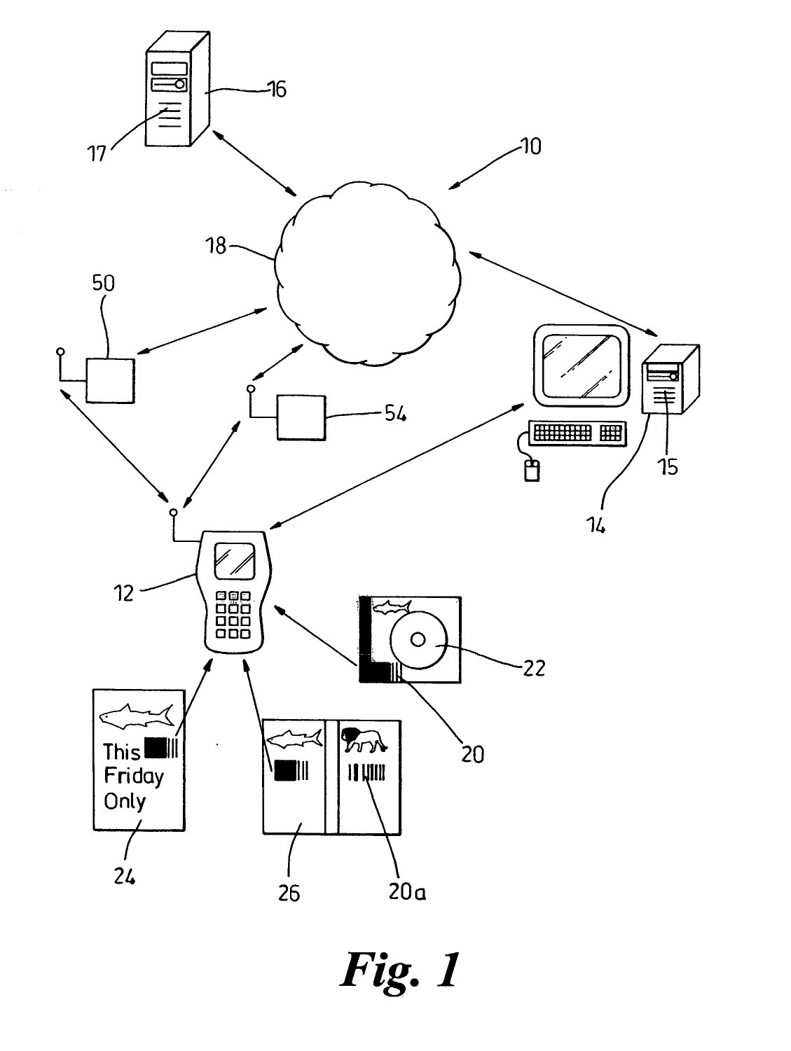

FIG. 1 is a schematic representation of a computer system according to the present invention; and

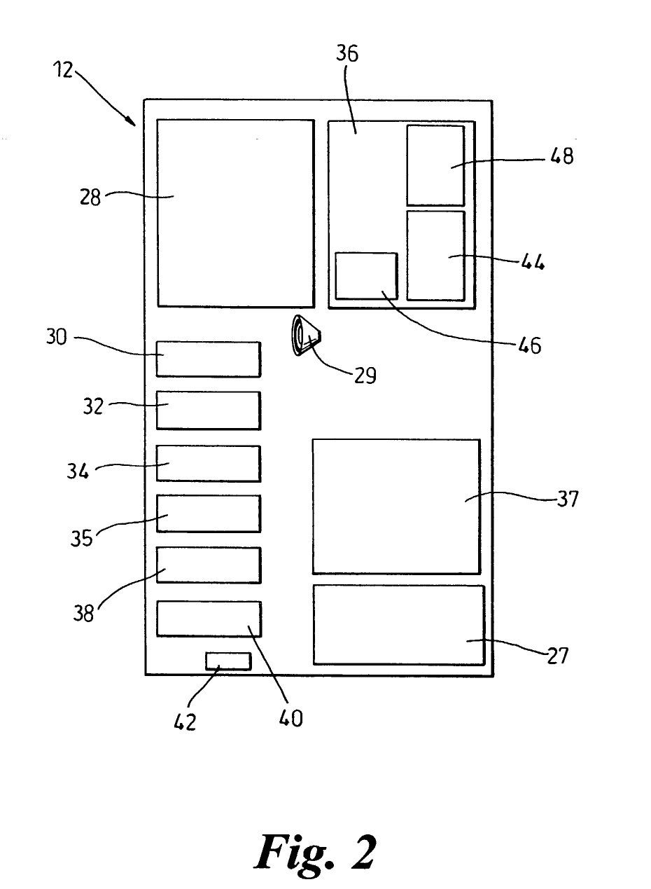

FIG. 2 is a diagrammatic representation of the internal layout of a portable data acquisition device of the present invention.

Referring to FIGS. 1 and 2 a computer system 10 comprises a portable data acquisition device 12, a PC 14 having a processor 15, a server 16 having a processor 17 and a network 18. Typically the network 18 is the Internet. The PC 14 and server 16 are connected via the network 18.

The data acquisition device 12 is a battery powered, hand held, pocket sized device that is used to acquire coded data 20, for example a barcode 20a. The data 20 is provided either on a product 22, a poster 24, a catalogue 26 or otherwise published, for example via the Internet.

The data acquisition device 10 includes a battery power source 27, a screen 28, a loudspeaker 29, a scanner 30, a magnetic reader 32 and a bar code reader 34, an infra-red transceiver 35, a processor 36, a user input 37. The data acquisition device 12 also includes a cellular transceiver 38, a wireless network transceiver 40 and a USB port 42.

The processor 36 includes a power management unit 44, a user interface (UI) management unit 46, and a data storage unit 48.

In use, a user of this data acquisition device 12 scans coded data 20 by swiping the device across the data into the device 12 using an appropriate reading device, for example, the scanner 30 for a textual, numerical or pictographic code, the magnetic reader 32 for magnetically coded data or the bar code reader 34 for a bar code 20a. The data is typically a bar code on a CD 22 or on a poster 24. The data read by the reading device is received by the event management unit 46 and stored in the storage unit 48.

The user of the device 12 can connect the device 12 to a PC 14 upon returning home or to the office and download the data from the device 12 to the PC 14. The download of data can take place via a USB cable (not shown) connected to the USB port 42. Alternatively, the download can be effected by a Bluetooth connection between the network transceiver 40 and a similar transceiver in the PC. Similarly, the network transceiver 40 can establish a wireless LAN connection between the device 12 and a LAN base station 50 to download the data, the PC 14 being connected to a LAN 52.

The data is transferred from the PC 14 over the network 18, to the server 16. The data is compared to entries within the database. If a match is found information relating to the product, for example, CD or video, is extracted from the database and passed back over the network 18 to the PC 14 where it is displayed, typically via a browser on a web page, or website, associated with a provider of the recordings.

The information will typically relate to such topics as the author of a work, and possibly their biography, other work by the author, similar works by other authors, release date of the work, details of the releasing company, catalogues number, availability information. The information can include video, audio and textual data.

Alternatively, the user may desire to access the additional product information whilst away from their PC 14 or have the information waiting for them upon their return to their base. An input at the user input 27 is passed to the event management unit 46 which activates the cellular transceiver 38.

The data is transferred from the device 12 via the cellular transceiver 30 to a cellular base station 54. The base station 54 is connected to the network 18. The data is passed onto the network 18 from the base station 54 and the additional product information is extracted from the database as hereinbefore described.

The data can be transferred from the device 12 to the base station 54 using known cellular telecommunications protocol such as GSM, GPRS, SMS or WAP.

The additional product information can be transferred either over the network 18 to the PC 14 or to the cellular base station 54 from where it can be transferred directly to the device 12 where it can be displayed and/or listened to via the device's screen 28 and loudspeaker 29.

The infra-red transceiver 35 is actuable to transfer the information to a printer (not shown) at which a hardcopy of the information can be produced.

It will be appreciated that the data acquisition device can be incorporated into a known portable device, for example, a mobile telephone or a personal digital assistant.

The database may hold excerpts from, or complete, tracks/videos which the user of the device 12 can request via the user input 37. The supply of the excerpts/complete tracks is undertaken being mindful of copyright considerations and will normally be undertaken by the publisher and/or distributor of the track/video with the permission of the copyright owner.

The excerpts can be output via the PC 14. Alternatively, the excerpts can be output via the acquisition device 12 via the screen 28 and loudspeaker 29.

This allows the user to preview a track or video prior to purchasing it. The user can purchase this track/video in any one of the following known manners: in a shop in the conventional manner, over the network 18 as a data file or alternatively, over the network 18 as a CD or video that will be delivered to their residence; linking directly to an on-line site on the network 18 from which the track/video can be purchased.

Each time a user accesses the database they will typically be asked to enter an identification code and a counter will increment each time they access a particular track/video. A limit is set on the number of times a given user can access a given track/video, for example 3 times. This prevents a user accessing the track/video repeatedly and using the systems as an alternative to purchasing the track/video.

1. A computer system comprising:
a portable data acquisition means for acquiring data relating to an audio/visual/audio-visual product;
a network element containing records relating to a plurality of audio/visual/audio-visual recordings, each of said records being arranged to store at least a portion of each of said recordings to which it relates along with additional audio/visual/audio-visual information relating to said recordings;
a connection means for connecting said data acquisition means to said network element;
processing means for identifying from said records an identified record relating to said acquired data; and
output means arranged to output said stored information relating to said identified record.

2. A computer system according to claim 1 in which said portable device includes a visual display upon which at least a portion of said additional information can be displayed.

3. A computer system according to claim 1 wherein said additional information comprises any one, or combination, of the following visual/audio-visual information: a video accompanying the record, a picture, a portion of text, a web-page and a web-address.

4. A computer system according to claim 1 wherein said portable data acquisition means includes an input means, and said output means is arranged to output at least a portion of one of said recordings stored upon said network element in response to a user operation of said input means.

5. A computer system according to claim 1 wherein a user of said system is directed to a Website associated with a provider of at least one of said recordings.

6. A computer system according to claim 1 wherein said data acquisition means comprises at least one, or a combination, of the following: a scanner, a bar code reader, a magnetic reader.

7. A computer system according to claim 1 wherein said connection means comprises a wireless network connection.

8. A computer system according to claim 7 wherein said wireless network connection is any one, or combination, of the following: wireless LAN, Bluetooth, GSM, UTMS, GPRS.

9. A computer system according to claim 1 wherein said network element includes a database and wherein said records are held on said database.

10. A method of acquiring and processing data comprising the steps of:
acquiring data relating to an audio/visual/audio-visual product by portable data acquisition means;
hosting records containing additional data relating to a plurality of audio/visual recording on a network element;
connecting said data acquisition means to said network element;
identifying which of said records corresponds to said acquired data; and
outputting, at least a portion of, said recording associated with said identified record.

11. A method according to claim 10 including the additional step of presenting said visual/audio-visual information on a display associated with said portable data acquisition device.

12. The method of claim 10 including providing said data as any one, or combination, of the following forms: textual, numerical bar codes, magnetically coded, passive radio frequency.

13. The method of claim 10 including connecting said network element to a network.

14. The method of claim 10 including connecting said data acquisition means to said network element by any one, or combination, of the following: wireless network connection, for example IEEE 802.11 or Bluetooth, temporary hardwired connection, USB, serial or parallel data buses, cellular telecommunication link including any one, or combination of: GSM, UTMS, GPRS, SMS and WAP protocols.

15. The method of claim 10 including providing said data acquisition means in at least one of the following forms: a scanner, bar code reader, magnetic reader.

16. The method of any one of claim 10 including providing said data acquisition means in a pocket sized, hand held, battery operated form.

17. A portable data acquisition device comprising:
a body housing a data capture device, storage means, a wireless data transfer means and a visual display, wherein said data capture means is arranged to capture data relating to an audio/visual/audio-visual product, said storage means is arranged to store said captured data and said wireless data transfer means is arranged to transfer said data to a network element, and further wherein said wireless data transfer means is adapted to retrieve from said network element visual/audio-visual information relating to said captured data and present said data on said display means.

18. A device according to claim 17 wherein said data capture means is at least one of: a scanner, a bar code reader, a magnetic reader or any combination thereof.

19. A device according to claim 17 wherein said wireless data transfer means is a wireless network transceiver.

20. A device according to claim 17 wherein said wireless data transfer means is a cellular telecommunications transceiver employing any one, or combination, of the following: GSM, UTMS, GPRS, SMS or WAP.

21. A computer readable medium having stored therein instructions which when running on a processor of a portable data acquistion device cause said device to perform the steps of:
acquiring data relating to an audio/visual/audio-visual product;
connecting said data acquisition means to a network element which hosts records containing data relating to a plurality of audio/visual recordings;
receiving from said network element at least a portion of said recordings associated with said identified record in said network element,
and presenting said received portion of recording to a user on a display associated with said portable data acquisition device.
